(19) United States
(12) Patent Application Publication
(10) Pub. No.: US 2018/0102110 A1
(43) Pub. Date: Apr. 12, 2018

(54) Module Interconnection Architecture and Methods for Display Systems Using Electroluminescent Devices

(71) Applicant: LANDMARK SCREENS, LLC, Palo Alto, CA (US)

(72) Inventor: Paul O. Scheibe, Minden, NV (US)

(21) Appl. No.: 15/289,107

(22) Filed: Oct. 7, 2016

(51) Int. Cl. G09G 5/12; G06F 3/14; G09G 3/32

(52) U.S. Cl. CPC G09G 5/12; G06F 3/1438; G09G 3/32; G09G 2300/026; G09G 2370/02; G09G 2360/06; G09G 2310/08; G06F 3/1446

(57) ABSTRACT

A display structure for displaying an image represented by a number of pixels includes: (a) multiple switches; and (b) multiple display modules, with each display module having (i) a network interface which allows the display module to be interconnected by the switches in a programmable network configuration with the other display modules; and (ii) electroluminescent devices (ELDs) of three or more basis colors implementing one or more designated groups of pixels of the image. The display modules are synchronized internally and with each other using a precision timing protocol of the programmable network configuration. Each module may further include control logic circuitry for controlling the ELDs and an associated set of ELD drivers.

### BACKGROUND

### 1. Field of the Invention

The present invention relates to image display devices that are formed out of electroluminescent devices¹ (“ELDs”), such as light emitting diodes (“LEDs”). In particular, the present invention relates to image display devices in which a display structure provided to display the image is implemented by a number of regularly placed display modules each being responsible for a specific group of pixels of the image. ¹ Electroluminescence refers to the phenomenon by which light is emitted from a material upon application of an electric field to the material.

### 2. Discussion of the Related Art

ELDs (e.g., LEDs) have been used to implement display structures in modern display systems. In a typical display system, each image consists of hundreds of thousands—even millions—of picture elements (“pixels”), which are displayed repetitively to represent still or motion images. Typically, the color and the luminous intensity of each pixel are supplied in the display structure by three or more types of ELDs, with each type of ELDs providing light of a specific basis (primary) color. In a modern display system, three or more basis colors are typically used. For example, the ELDs assigned to implement a pixel may include ELDs emitting red light, ELDs emitting green light and ELDs emitting blue light. The light emitted by the ELDs of a pixel is perceived by the human observer from a distance as a single color. All such colors collectively constitute a “gamut.”

ELD-based display structures have found applications in large display systems, such as electronic billboards along a freeway, or the overhead displays in a sports stadium. For convenience in construction, installation and maintenance purposes, such a display structure is typically implemented by many display modules, with each display module providing ELDs and supporting circuitry to implement an assigned set of pixels. In some systems, further modularity is provided by organizing the assigned set of pixels into groups of pixels. As each ELD is controlled independently of other ELDs, a large amount of data flows to each display module whenever the image to be displayed changes. For example, in a motion picture, 24 image frames are displayed per second. Similarly, in conventional television, 30 image frames are displayed per second (in some instances, each image frame consists of two interlaced fields).

A contemporary conventional display system uses a large number of parallel wires or cables to carry signals for data transfers, control, sensing and monitoring. Typically, a large quantity of connectors are required to connect these wires or cables into and out of the display structures, as well as between components. Such a system incurs numerous costs, such as manufacturing and maintenance costs for the interconnections. In addition, such a large and complex system has difficult reliability issues. Consequently, alternative methods for accomplishing the interconnections are desired.

Therefore, structures and methods are desired for to accommodate the high data rates in a ELD-based display system and to reduce the number of interconnections. In addition, enhanced modularity, extensibility, cost reduction, operational flexibility, reliability, and serviceability in such structures and methods are desired.

### SUMMARY

According to one embodiment of the present invention, a display structure for displaying an image represented by a large number of pixels includes: (a) multiple switches; and (b) multiple display modules, each display module having (i) a network interface which allows the display module to be interconnected by the switches in a programmable network configuration with the other display modules; and (ii) electroluminescent devices (ELDs) providing three or more basis colors to implement a designated group of the pixels of the image. In this embodiment, the display modules are synchronized with each other using a precision timing protocol carried out in the programmable network configuration. Each display module may further include signal processing and control logic circuitry for controlling the ELDs and corresponding ELD drivers.

In one embodiment, the programmable network configuration operates under the Internet Protocol, and the precision timing protocol is provided by the Precision Timing Protocol operating over the Internet Protocol. To provide hardware support, the control logic circuitry may include a Precision Timing Protocol transceiver integrated circuit.

The ELDs of the display module may be organized as ELD strings each providing ELDs of the same basis color.

The control logic circuitry of a display module may include diagnostic circuitry for determining integrity of the ELDs implementing the pixels of the image.

The display structure may further include a distributed computing resource providing imaging processing capability to support the operations of the control logic circuitry in the display modules over their respective designated groups of pixels. The distributed computing resource may be formed out of programmable image processors distributed throughout the display structure, interconnected by the switches in the network configuration. The image processors may also be embedded in the display modules.

Taking advantage of precision timing provided by the precision timing protocol, the distributed computing resource enables hot-swapping of software and firmware components of the display structure at precisely determined times. The distributed computing resource may communicate diagnostic and status signals among the display modules and a control system external to the display structure.

The present invention is better understood upon consideration of the detailed description below in conjunction with the accompanying drawings.

### BRIEF DESCRIPTION OF THE DRAWINGS

FIG. 1 shows a hierarchy of components in ELD-based image display system.

FIG. 2 shows a simple programmable network configuration in display structure 200, in which router or master switch 201 controls switches 202-1, 202-2, . . . , 202-n, each of which in turn connects a set of modules (e.g., 203-1 to 203-m), according to one embodiment of the present invention.

FIG. 3 shows module 300, according to one embodiment of the present invention.

### DETAILED DESCRIPTION OF THE PREFERRED EMBODIMENTS

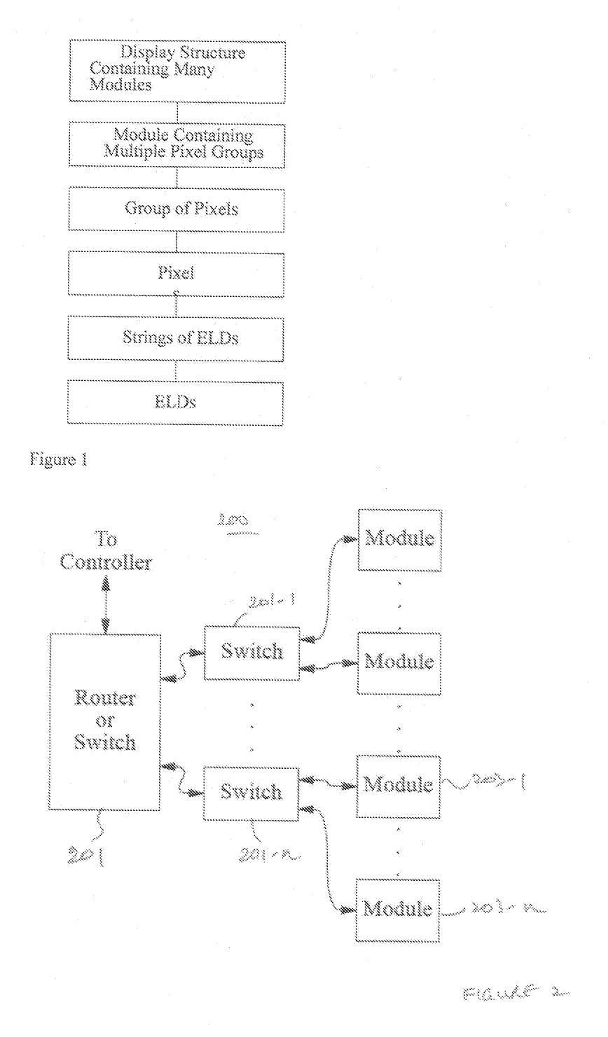

According to one embodiment of the present invention, a large ELD-based display system may be organized as a hierarchy of electrical and electronic components, such as shown in FIG. 1. As shown in FIG. 1, the component hierarchy of the image display system (e.g., an electronic billboard) may consist of a large number of ELD-based display modules, with each ELD-based display module being assigned to display on the display structure one or more dedicated groups of pixels. The physical location of each display module determines which groups of pixels are assigned to the display module. Each pixel with a display module is implemented by a number of ELD strings, with the ELDs in each ELD string being of the same primary color. The ELDs of each ELD string are driven by an associated ELD driver circuit. Under the component hierarchy of FIG. 1, the timing, control, status and fault-reporting data flow between the hierarchical levels. The hierarchical organization provide system-level functions efficiently.

The inventor of the present invention observes that the lowest level opportunity for networking is located between the pixel group level and the pixel level, inclusive, as data flow between that level and any of the higher levels in the hierarchy may be achieved (except for power) using digital signals. Furthermore, for repair and maintenance purposes, the display module level is a convenient unit for a display structure that is shorter than a few meters on a side, or at the pixel group level for a display structure that have dimensions exceeding a few meters. Display structures for video wall, outdoor advertising or outdoor sports applications may consist of many display modules each typically implementing a portion of the display structure measuring one meter or less on a side. At present, for such a display structure, coordination among the display modules—especially among those display modules implementing pixel groups that are physically distant—requires special treatment (e.g., custom cabling to ensure timing integrity).

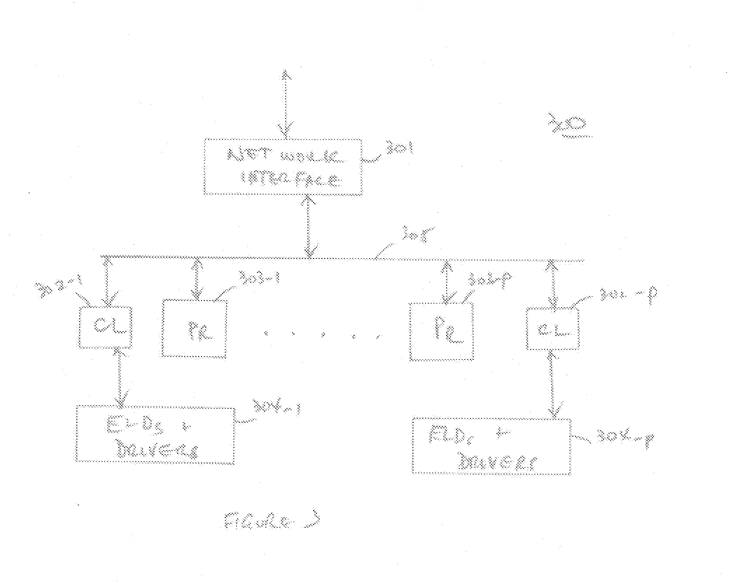

The inventor recognizes that many network configurations that allow scalability and distributed control and data processing are possible. For example, FIG. 2 shows a simple programmable network configuration in display structure 200, in which router or master switch 201 controls a set of switches 202-1, 202-2, . . . , 202-n. In FIG. 2, switches 202-1 to 202-n each connects a set of display modules (e.g., 203-1 to 203-m). The data flow associated with the display modules are aggregated by the switches and data flows through the switches are aggregated by the router(s). All data, timing, control, status and fault indication signals are communicated over the programmable network, thus minimizing the required quantities of connectors, wires and cables. Not shown in FIG. 2 is a means for implementing an important aspect of control—i.e., the control of relative timing among the display modules to ensure that the display elements of each display module are driven at a proper time for the pixel groups assigned to that display module, regardless of where the assigned pixel groups are located in the displayed image. As discussed below, one such means may be implemented by software or firmware using a standard timing protocol over the internet protocol² (IP). ² The Internet Engineering Task Force (IETF, at http://www.ietf.org) maintains a repository of the IP standards and “Requests for Comments” (RFCs, at http://www.rfc-editor.org/standards)

FIG. 3 shows display module 300, according to one embodiment of the present invention. For example, as shown in FIG. 3, display module 300 includes network interface 301 for the display module. Network interface 301 handles communication between display module 300 and other elements of the display structure, as well as with devices external to the display structure. Network interface 301 may be implemented using industry standard network components, such as switches implementing IP. Network components implementing industry standard protocols are available in volume from many suppliers. Using industry standard network components allows the use of standard communication protocols over the network infrastructure. Such standard communication protocols are widely available and may be typically implemented as software or firmware of the network components. These standard protocols make internal and external interfaces readily available to the underlying physical network, allow the network configuration to be programmable, and provide both reliability and reduced cost. Some examples of standard communication protocols include, for example, the IP and ethernet³ protocols, which are widely used and understood. ³ Ethernet standards IEEE 802.3 and others in the IEEE 802 family are available from the IEEE; see http://standards.ieee.org/ for these and other standards.

As shown in FIG. 3, data and control signal communication within display module 300 may be carried out over internal data and control bus 305 within the display module. Display module 300 may include image processing computers 303-1 to 303-p each being responsible for a group of pixels handled by display module 300. The image processing computers of the display modules distributed throughout the network form a distributed computing resource for the display structure of the image display system. This display module-based distributed computing resource allows scaling, which enables very large display structures to be built. With this distributed computing resource, full-motion surround imagery and many other large-scale image display features may be achieved. Alternatively, image processing computers need not be embedded within the display modules, e.g., provided alongside the display modules. In such a system, the image processing computers and the display modules are interconnected by the programmable network.

According to one embodiment of the present invention, the distributed computing resource communicates internally and externally using an IP stack, which may include a host of data communication protocols, such as NTP⁴ (network time protocol), PTP⁵ (precision time protocol), TCP⁶ (transmission control protocol), RTP⁷ (real-time transport protocol), UDP⁸ (user datagram protocol) and other associated protocols, to provide broad communication functionality in an ELD-based display structure. One may also use ethernet for providing link-level control, timing and data transfer. ⁴ Mills, D. L., “Network Time Protocol,” RFC 958 superseded by RFC 5905, September, 1985.⁵ IEEE std. 1588-2008, “IEEE Standard for a Precision Clock Synchronization for Networked Measurement and Control Systems.” July, 2008.⁶ Postel, J., “Transmission Control Protocol,” RFC 793 superseded by RFC 6528, September, 1981.⁷ Schulzrinne, H., “Real-time Transport Protocol,” RFC 1889 superseded by RFC 3550, September, 2003.⁸ Postel, J., “User Datagram Protocol,” RFC 768, August, 1980.

FIG. 3 also shows control logic circuits 302-1 to 302-p, which control the ELD strings and their drivers 304-1 to 304-p. Control logic circuits 302-1 and 302-p also implement diagnostic and fault detection circuitry that monitors and maintains the ELD strings. For example, in one embodiment, redundancy is provided such that the ELD strings in the display module may be reconfigured to maintain functionality when fault is detected in one of the ELD-strings. Timing, control, data, status and fault indicators in display module 300 may all be communicated over the programmable network of the display structure. Use of image processing computers 303-1 to 303-p embedded within display module 300 (or within groups or sub-groups of pixels) allows extensive status determination and fault detection as well as detailed control of the associated data flows and the integrated circuits driving the ELDs. Remote indication of status and diagnosis of faults are also greatly facilitated with the availability of embedded computers, such as image processing computers 301-1 to 301-p. The network-based architecture of the display structure, such as the network of display structure 200 shown in FIG. 2, make possible status reporting and remote diagnostic and maintenance down to the pixel group level or even lower. In some embodiments, optical fiber, wire cables or wireless connections can be used for the physical links. Specifications for supporting the specific communication protocols may be found, for example, at the links to the protocols mentioned above.

In addition to simplifying use and economy, the display modules disclosed herein have important properties that individually and together provide many significant and unique advantages. One key aspect that enable many of the properties is the unique network-based architecture that readily accommodates distributed precision time accurate to below the millisecond level.

Individual display modules may be tested independently of other parts of the display system. Testing of modules during manufacture provides detailed quality assurance at the unit level. Field maintenance is accommodated by isolation of faults at the display module level. Self-diagnostics facilitates either replacement of the display module or of pixel groups within a display module. As continuous, uninterrupted operation of the display structure is necessary in many applications, necessary service upgrades and maintenance operations in the display structure may be carried out “hot” (i.e., taking place simultaneously with normal operations), taking advantage of the precision timing at the display system level, for example.

Any of a number of precision timing protocols may allow the display structure to synchronize both internally and externally to a universal time base that is accurate to at least the millisecond level. Such precise timing may be achieved using the PTP protocol, for example. Hardware support for PTP, such as the DP83640 precision time protocol transceiver from Texas Instruments, may be implemented in control logic circuits 302-1 to 302-p. With precision timing, firmware or software upgrades and software hot swaps may take place at precisely determined times, e.g., between image processing operations. In addition to providing data for detailed logging of activities, precision timing may be used to instantiate firmware or software that removes, replaces, upgrades or tests existing parts of the operating system that controls part or all of a module. Use of a suitable programming language that supports hot-swapping (e.g., Erlang⁹, Elm¹⁰, Elixir¹¹, and Pike¹²) further facilitates code changes without stopping the system. ⁹ See. e.g., http://www.erlang.org¹⁰ See, e.g., http://elm-lang.org¹¹ See, e.g., http://elixir-lang.org¹² See. e.g., http://pike.lysator.liu.se

When power is first applied to a system, individual display modules are required to be predictably started and internal operations are required to be synchronized with the system within a prescribed time period. System operations should not be materially affected if some individual display modules are faulty. Additionally, synchronization of a display module's internal operations should occur without further action when a fault is repaired. Distribution of precision timing (e.g., via components that support IEEE 1588 PTP) is an essential ingredient in providing these start-up and fault tolerance capabilities.

In the prior art, management of software, firmware or hardware is laborious, prone to error and requires system shutdown to carry out. Application of hot-swapping capability, enabled by distribution of precision timing, according to the present invention, simplifies configuration management through the ability to rapidly instantiate trials of updates and rollback, if necessary.

The present disclosure recognizes that data and time distribution as now practiced in ELD-based display structures are expensive and unreliable. Distribution of data to multiple modules of an ELD-based display structure can be significantly simplified, made more robust and more economical using networking principles. Using networking principles, solutions have been disclosed herein that utilize established industry standard protocols supported by widely available hardware and software that has proven reliability and low cost.

The above detailed description is provided to illustrate specific embodiments of the present invention and is not intended to be limiting. Numerous modifications and variations within the scope of the invention are possible. The present invention is set forth in the appended claims set out below.

I claim:

1. A display structure for displaying an image represented by a plurality of pixels, comprising:
a plurality of switches; and
a plurality of display modules, each display module comprising:
a network interface which allows the display module to be interconnected by the switches in a programmable network configuration with the other display modules; and
electroluminescent devices (ELDs) of three or more basis colors implementing one or more designated groups of the pixels of the image;
wherein the display modules are synchronized with each other using a precision timing protocol of the programmable network configuration.

2. The display structure of claim 1, wherein each display module further comprises control logic circuitry for controlling the ELDs and an associated set of ELD drivers.

3. The display structure of claim 2, wherein the programmable network configuration operates under the Internet Protocol.

4. The display structure of claim 3, wherein the precision timing protocol comprises the Precision Timing Protocol operating over the Internet Protocol.

5. The display structure of claim 4, wherein the control logic circuitry further comprises a Precision Timing Protocol transceiver.

6. The display structure of claim 2, wherein the ELDs are organized as ELD strings each comprising ELDs of the same basis color.

7. The display structure of claim 2, wherein the control logic circuitry further comprises diagnostic circuitry for determining integrity of the ELDs implementing the designated groups of pixels.

8. The display structure of claim 2, further comprising a distributed computing resource providing imaging processing capability to support the operations of the control circuitry in the display modules over their respective designated groups of pixels.

9. The display structure of claim 8, wherein the distributed computing resource comprises a plurality of image processors interconnected by the switches.

10. The display structure of claim 9, wherein each image processor is embedded in one of the display modules.

11. The display structure of claim 8, wherein the distributed computing resource undergoes hot-swapping of software and firmware at precisely determined times using the precision timing protocol.

12. The display structure of claim 8, wherein the distributed computing resource communicates diagnostic and status signals between the control logic circuitry of each display module and a control system external to the display structure.

13. The display structure of claim 1, wherein the designated groups of pixels implemented by the display modules are non-overlapping during operations.
